(19) United States
(12) Patent Application Publication
(10) Pub. No.: US 2011/0029915 A1
(43) Pub. Date: Feb. 3, 2011

(54) Layered desktop system

(75) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(73) Assignee: HARRIS TECHNOLOGY, LLC, Rancho Santa Fe, CA (US)

(21) Appl. No.: 12/534,133

(22) Filed: Aug. 2, 2009

(51) Int. Cl. G06F 3/048; G06F 9/46

(52) U.S. Cl. 715/781; 719/313

(57) ABSTRACT

Different windows and layers on the computer can be either shown on the local screen or projected. Some windows on the local screen might not be projected windows. The user can check email or do other personal things in the non-projected screen without seeing those things on the projection.

### BACKGROUND

Computer systems, for example laptops, are often used for projection. For example, a user may attach their laptop into a port that is used for projecting the output of the laptop onto a screen. This may be done for example, during presentations, and the like.

The video hardware in the laptop conventionally creates a copy of exactly what is being displayed on the user's desktop by copying the screen buffer and projecting or otherwise displaying that copy onto the projecting screen. Everyone in the area of the projection screen can thus see what the laptop user sees.

### SUMMARY

The present application describes a layered desktop system in which a number of different layers are provided. Each of the layers have different characteristics. According to one embodiment, some of these layers are displayed by the external display, while others of the layers are not so displayed.

Other embodiments describe ways to visually distinguish between the different “windows”.

The inventor recognized a number of problems that occur with this system. First of all, when the user is using an external display, that external display shows exactly what is on the user's desktop: both the desirable and the undesirable parts. For example, pop-ups that occur due to the user's mail or other characteristics are displayed on the projector. This can be an embarrassing scenario. Also, a user in a meeting often wants to use their laptop for various purposes. The user cannot use their laptop without everybody who is seeing the external display seeing everything on the external display.

Moreover, when the user is looking for something, and they don't know exactly where that thing is, they often want to scroll in order to find it. However, scrolling, while perhaps acceptable on the local screen as controlled by the user, can cause serious problems for the other users, including vertigo and headaches.

### BRIEF DESCRIPTION OF THE DRAWINGS

These and other aspects will now be described in detail with reference to the accompanying drawings, wherein:

FIG. 1 shows a laptop as displaying on an external display screen.

(Fill in the rest of the drawings here)

[symbol]

### DETAILED DESCRIPTION

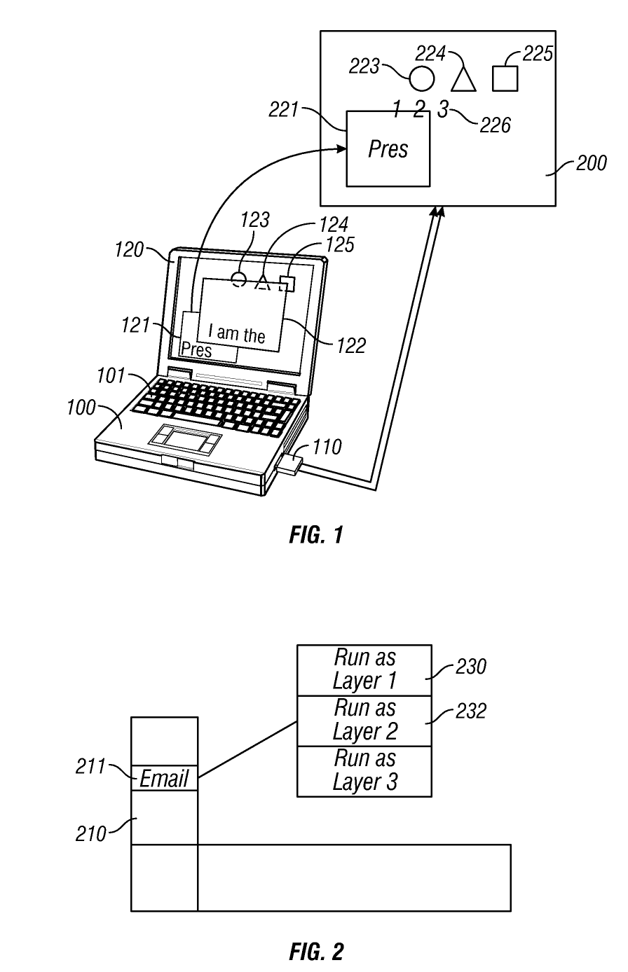

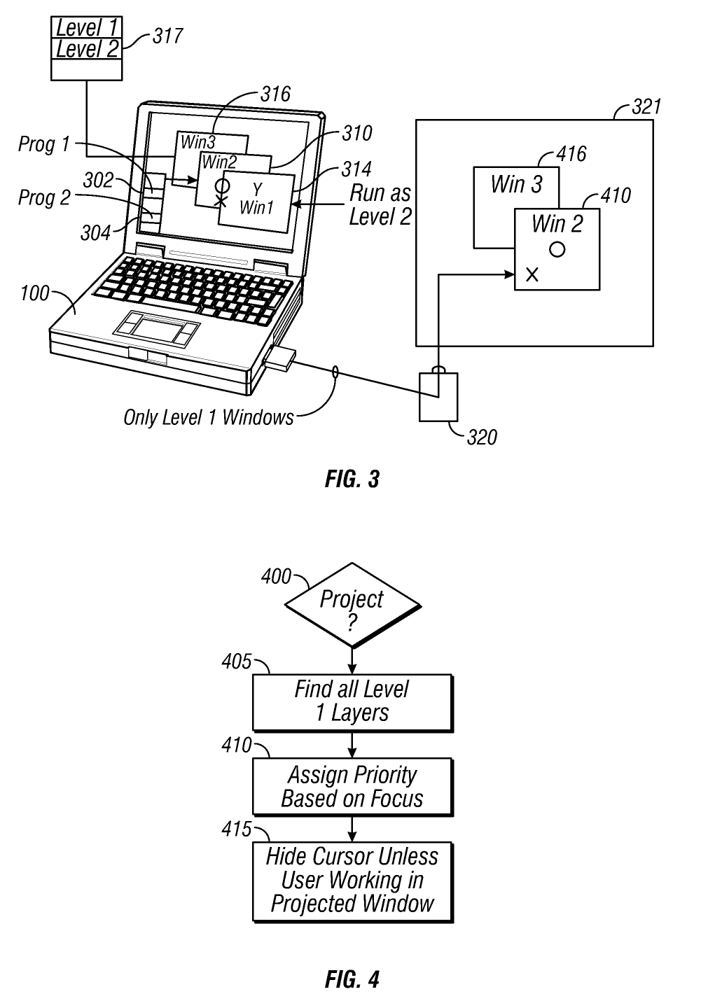

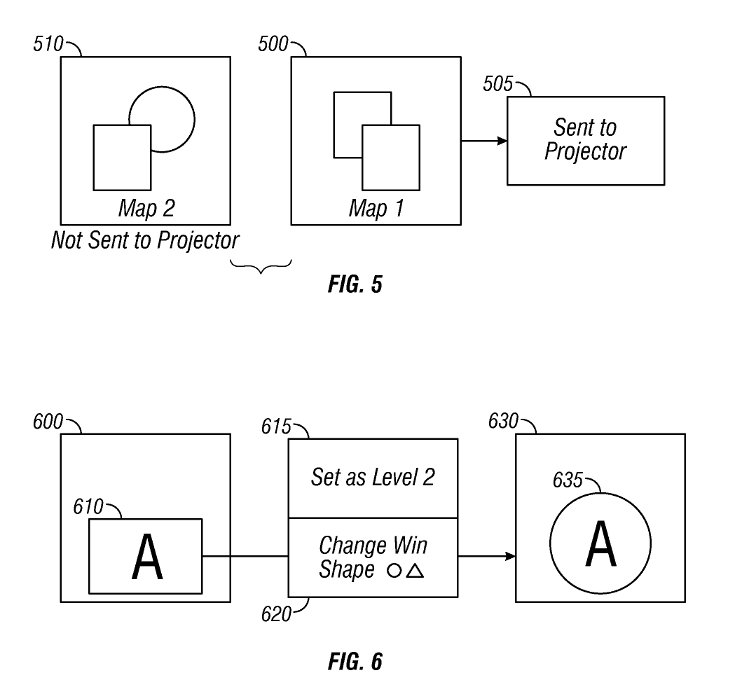

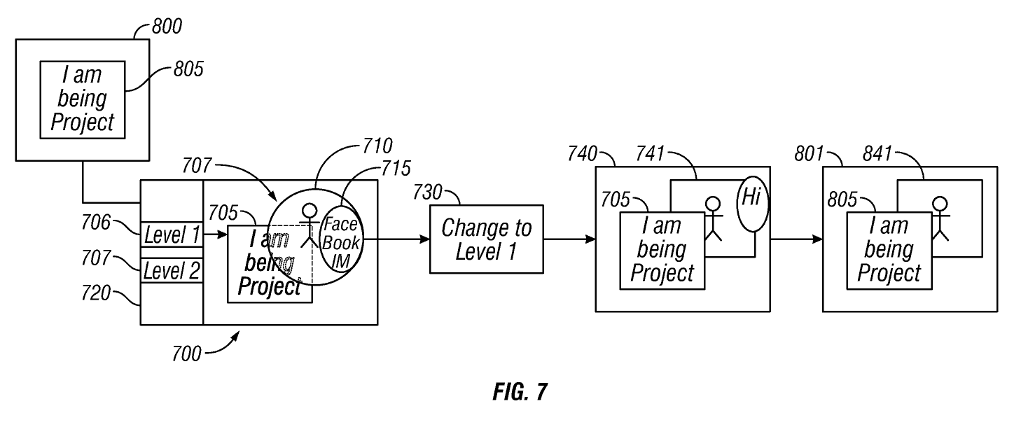

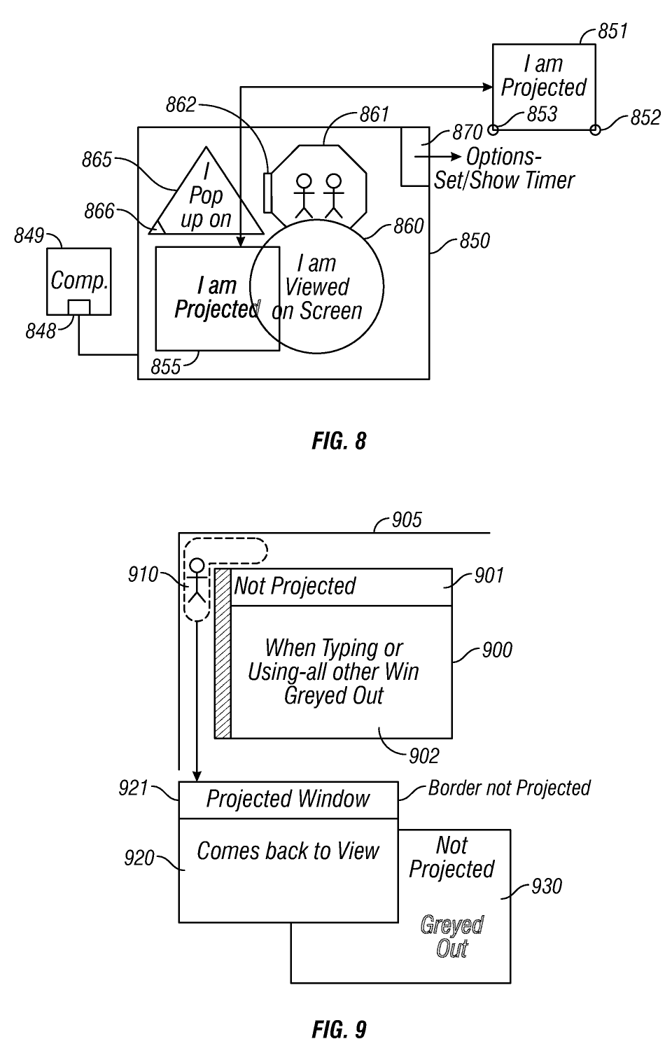

An embodiment is shown in FIG. 1. A computer 100, such as a laptop, includes an output port 110 which can be a wired port such as a VGA output port, or can be for example a wireless port such as wireless HDMI, Bluetooth, or other similar kind of port. Any kind of output port which is capable of producing an output to an external screen, projector, or other video display such as a pixel based LED screen can be used for this purpose. Any of these things may be generically referred to herein as a projector in this disclosure, but it should be understood that such a “projector”, might not actually “project” the light.

The computer 100 includes a user interface 101, and a screen 120. The screen shows a number of objects thereon. Those objects can each be anything that can be displayed on a computer screen, e.g, a window, a shortcut, or any other item. The objects are shown as 121, 122, 123, 124, 125 on the computer screen. In an embodiment, some of these objects are projected on the auxiliary screen, while others of the objects are not so projected. The objects may be individual objects, or may be layers which consist of a number of different objects. In an embodiment, the object 121 is displayed on the auxiliary display screen 200 as 221. Similarly, the object 123 is displayed on the display screen as 223, the object 124 is displayed on the auxiliary screen 200 as 224, and the object 125 is displayed as 225.

The object 122, however, is a non-projected layer. While the object 122 is displayed on the local display screen 120, it is not projected on the auxiliary screen 200. Therefore, the user can use the object 122 in any desired way, e.g. for an e-mail program, to edit a document, or view the Internet on the local screen 120, but viewers who view the auxiliary screen will not see the output from this program at all.

Note also that some of the objects such as 123, 124, 125 when shown on the main display screen 120 are partly masked by the non-projected object 122. In an embodiment, this is because the non-projected object 122 is set to have priority over the objects 121, 123, 124, 125. In embodiment, each of these objects can be a single object, or can be multiple objects. The object or objects form a layer that is viewed separately from the other layers, e.g., with higher or lower priority than the other layers.

The object 122 in this embodiment has priority on the main/local viewing screen, since it is in this embodiment used for the user. However, when displaying on the auxiliary display screen 200, the corresponding displays are completely displayed. That is, on the main display screen 120, the item 123 may be shown only as a half circle, since it is half obliterated by the non-projected layer 122. However, when projected onto the auxiliary display screen 200, the complete shape of the item 123 is shown. Similarly, the number “123: shown is 226 is completely behind the layer 122 in the main display screen 120. However, this number is completely displayed on the auxiliary display screen 200.

FIG. 2 illustrates how a program and/or a window displaying that program can be selected to run as a layer. In FIG. 2, a program such as an e-mail program can be selected from menu 210. The menu 210 may be part of a conventional selection menu. One of those items 211 is the e-mail program. The user can select this item as normal, to run this in the default mode. However, the user can also make an expanded selection e.g. in the Windows operating system via a right-click menu. That menu allows running any specified program in a specific way: for example as a layer 1 program at 230, or as a layer 2 program at 232. For example, the layer 1 program may be the conventional way of running the program where it is shown both on the main display screen and on the projected display screen. The layer 2 program may be a screen which is shown only on the main display screen, semitransparent as shown by layer 122, so that other layers can be seen through the layer and not projected. Other layer options may also be run such as layer 3, which may be a background program that would not be seen at all through the semitransparent window. For example, the display of “1 2 3” (226 in FIG. 1) may be a layer 3 program that is only run in the background.

Other “layers” may other may also be selected in a similar way. Moreover, while the above discusses these as being layers, e.g., being labeled by the name “layer 1” or “layer 2”, they can of course have descriptive names for their operation. For example, instead of being labeled as “layer 1”, the menu may select this as “run this as a normal program”, “run as a project or a non-projected program that is semitransparent”, or some other descriptive term.

FIG. 3 shows the result, where for example program 1, selected as 302, may be run as window number 2 as a standard “level 1” program. This is shown as window 310. If projected (by projector 320) on the external screen, this is shown as window 410. This shows all of the items on the window number 2, including those that were masked or semi-masked by other windows.

Program 2 selection, in contrast, at 304, is selected to run as level 2. This creates a window 314 which is shown on the main screen, shown covering the other windows. In this embodiment, window 314 is not projected. No facsimile of 314, for example, is projected by projector 320 onto screen 321.

Window 3, 316, is also projected as 416. Note, however, that Window 3 has been projected with a lower priority than window 2, and hence window 2 is projected “over” Window 3.

The computer 100 may run a program according to the flowchart of FIG. 4. For example, 400 in FIG. 4 represents a detection that the program is going to project.

At 402, the program finds only the level 1 layers. In other embodiments, however, other layers such as layer 3 may be projected, and the program may find those layers also.

At 410, the projected layers are assigned priority of projection based on “focus”, meaning that the last use of that window is assigned to have a higher window priority than other windows that were used less recently.

For example, even if the user is typing into window 1 314, window 2 will still get priority of focus since it was used more recently than window 3 316.

At 415, the cursor on the computer 100 is hidden unless the user selects a projected window to have focus. Therefore, unless the user is actually interacting with the projected window, the cursor is not shown during the display. This allows the user to freely work in the “hidden” window during this time of projection, and their work is not projected.

The above has described how programs can be started as having a specific priority. In addition, however, a program once opened can be changed in level. For example, in an embodiment, the user can invoke a supplemental menu command, for example by a right-click, to bring up a menu shown as 317. That menu can be used to change the priority to level 1, level 2, etc. As previously described, although the terms level 1, level 2 are used for this description, other descriptions can be used, such as projected or non-projected.

According to another embodiment, the different windows of different “layers” are shown differently on the screen. FIG. 5 illustrates how the different maps can be associated with the screen. According to FIG. 5, map 1 500 is sent to the projector at 505. Map 2 510 is not sent to the projector. Within each map, the last application that was selected gets priority and hence focus. The priority of display is handled unfocused—that is the last focused app is displayed on top for both the projected map 500 and the non-projected map 502.

FIG. 6 illustrates another embodiment where the Windows shape is set according to the level. In FIG. 6, the screen 600 which may be either the computer screen or the projection screen has a level 1 window shown as 610. This is being projected. The user can select a menu which changes the level of the window, here the command 615 setting the window 610 to a level 2 window. At 620, the system also changes the shape of the window, where the new window shape indicates that the new window now has a different priority. Computer screen 630 shows the new outer shaped window 635. The different outer shape of the window has been changed to indicate that it is now a non-projected window. The same content still remains within that window, however now that window is not projected. In addition, by simply looking at the screen, the user can determine that the particular window will not be projected, since certain window shapes will be projected, and other shapes are not projected. This allows the functions of the windows to be determined at a glance.

FIG. 7 shows how multiple windows can be changed in this way. 700 shows a computer screen, with a first window 705 that is a projected window and hence has a rectangular outer shape to indicate that this is a “normal” window. When an external projector 800 is attached, the window 705 will be projected by the external projector 800 as 805.

However, windows which have other functions, e.g, non-projected windows, have different outer shapes. In FIG. 7, non-projected windows are shown with circular outer shapes. The windows 710 and 715 are not projected. The window 710, for example, may be an image; while the window 715 may be an instant message program such as Facebook IM. These programs has been selected from a conventional menu 720. The program in window 705 has been selected to level at 706, and the program in windows 710 and 715 have been selected to level 2 by menu item 707. These may be default levels, for example for the program. For example, instant message programs may always default to being level 2 programs which are not projected. Presentation programs, such as powerpoint, in contrast, may always default to being level 1 programs that are projected.

The eventual projection shown on screen 800, shows only the projected layer 705. However, in the embodiment, the program 710 can be changed to level 1 at 730. This produces a new computer display screen shown as 740. The screen 740 includes the original window 705, but also includes the window 710 now with a different outer shape here rectangular. The new window 741 is now a projected window. When projected, as shown as 801, the projection includes the projection 805 but also includes the image projection now shown as 841.

When the characteristics of the window are changed, its outer shape is also changed in this embodiment. Therefore, for example, projected windows may have rectangular outer shapes; non-projected windows may have oval outer shapes.

These differing outer shapes may be only on the main screen, with all projections on the external screen having the same outer shape. Alternately, the shapes can differ on both screens, for example.

FIG. 8 shows how multiple screens can be shown on a local screen, and have different characteristics. The local computer screen 850 can be displayed onto a projection screen 851. The local screen 850 is driven from a port 848 on computer 849. For example, port 848 may be a VGA, DVI, HDMI or other form of data-outputting port. The different windows can each have a different outer shape, to denote their different operations. In this embodiment, the windows are shown with different outer shapes to denote these different functions, however it should be understood that different ways of distinguishing between the windows can alternatively be used. For example, the windows can be displayed in different colors to denote their different functions, can have different borders to denote their different functions, or can otherwise have different views to represent the different functions of the windows or programs.

The window 855 is a level 1 window as shown in previous embodiments, which means that the window will be one that is projected. The other windows on the local screen 850, however, are not projected.

In this embodiment, the projected window can be shown as a window size screen on the local screen 850, but as a full projection size display on the projected screen 851. This operation may be done for all level 1 windows, or may be a function of a different level window, e.g., a level 4 window, meaning that the window is automatically expanded to projection screen size when projected.

The projection screen 851 also includes cameras 852, 853. The cameras may obtain a view of the audience that is watching the presentation. The camera view may be shown on the main screen 850 as window 860 again having a different outer shape or other way of distinguishing this window from other windows. This camera view shows the audience. The window may be a pop-up that occurs only when there is a specified change in the image being viewed by the cameras, for example when someone in the audience stands up to walk away, or someone puts their head down or the like. This may facilitate a presenter better gauging their audience's reaction to the presentation, since the presenter can view an image of their overall audience on their local screen, and that audience view is not projected. For example, this audience may always be shown as a window, or may only be pop up. The window showing the audience may be transparent, or not transparent. In the embodiment, there may be two separate windows 860, 861, which respectively show the views from the different cameras. Alternatively, there can be one window 861.

The window 860, for example, can be a level 2 screen, such as an instant messaging program or the like. The window 861 may include controls for the camera shown as 862. These controls can control pan and tilt of the cameras 852, 853. For example, this can allow the user to focus in on a specific area of the audience or specific person.

In an embodiment, each camera can provide a separate window or alternatively there can be one stitched window for both cameras which “stitches” together the outputs of the two cameras.

The window 865 represents a pop-up window. This window may pop up on either or both of the main screen or the projection screen. When it pops up only on the main screen, it may pop up with a special control 866 that allows the presenter pop up that same window on the projection screen if desired. For example, this may be a note as part of the projection, or can be a visual page, or a message associated with the presentation, or an indication of how long it will be until a break. The pop-up window can be used, for example, so that the presenter knows how long they have finished presenting a specified portion. This also allows telling the audience that lunch is available in the room next door, or that a break is imminent.

The actions of this pop up window may be set as part of the options in the options screen 870 which may include a show timer with a 30 minute presentation that counts down from 30, and provides display on the main screen of the countdown, or warnings only at certain points during the presentation, e.g. at halfway through, or 10 minute warnings, etc.

FIG. 9 shows an alternative embodiment, where a border of the screen is changed instead of screen shape. For example, 900 shows a non-projected window on the computer screen 905. This window 900 includes a border 901 that indicates window 900 is not being projected. In this embodiment, when typing on this window 900, for example in the area 902, all of the other windows in the display 905 are grayed out. Therefore, the projected window 910 is grayed out in this embodiment while the user is typing in the window 902. However, when the user clicks the window 910, it comes back into view shown is 920, showing that it is a projected window with a header 921. When this window comes back into view, the previously in focus window, is then shown as grayed out window 930. Even when grayed out, the words in the window “non-projected” can still be seen.

In one embodiment, the distinctive borders such as 901, 921 are shown only on the main screen, and are not projected. That is, the borders do not form part of the layer that is mapped to the projection part.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, the “projection” is intended to include display of information from the computer on any other display device, including a monitor, LED device, television, or any other device. The term “layer” is intended to denote any displayed part.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer system comprising:
a processor, running first and second programs;
a first output port for a local display, both of said first and second programs being output over said first output port for the local display;
and
a second output port for a remote display, wherein said second output port only provides output for only said first program for a remote display, and does not display said second program on said second output port for said remote display.

2. A computer system as in claim 1, wherein said second output port for said remote display is an output for an external projector.

3. A computer system as in claim 1, wherein said first output port produces output that displays a complete desktop, and second output port produces output that displays said complete desktop of said local display, other than said second program.

4. A computer system as in claim 1, further comprising a user interface on the computer system that controls interacting with both said first and second programs.

5. A computer system as in claim 4, wherein said user interface interacts with said second program to change a display of said second program on said first output port, and said second output for said remote display continues to display only said first program while said user interface is interacting with said display of said second program, and does not display said second program that is being interacted with using the user interface.

6. A computer system as in claim 1, wherein said first program is displayed to have a first outer shape on said local display, and said second program is displayed to have a second outer shape different than said first outer shape on said local display.

7. A computer system as in claim 4, wherein said user interface enables changing said second programs such that said second program is also displayed on said remote display after said changing.

8. A computer system as in claim 1, wherein said processor controls running programs, and controls selecting whether running programs will be displayed on said remote display or will not be displayed on said remote display.

9. A computer system as in claim 1, wherein said processor determines parts of a local display which are to be sent to the second display port, and only sends those parts to the second display port.

10. A computer system as in claim 9, wherein said parts which are not sent include labels on the first display indicating whether the parts will be sent to the second display.

11. A computer system as in claim 1, wherein said first program that will be sent to the second port is shown in a first way over the first port, and said second program which will not be sent to the second port is shown in a first in a second way different than the first way over the first port.

12. A system as in claim 1 further comprising a display, connected to said first port, locally displaying information about said first port.

13. A system as in claim 11, wherein said first and second programs are shown with different outer shapes.

14. A system as in claim 11, wherein said first and second programs are shown with labels representing characteristics of the programs.

15. A system as in claim 14, wherein said labels are not sent as part of the shape to the second port.

16. A method, comprising:
using a computer to create a display output that shows multiple different programs, including at least a first program that is run in a way to be output over a first display port, and a second program that is run in a way to not be output over said first display port,
using the computer to allow interacting with both of said first and second programs; and
using the computer to provide output of both the first and second programs on the first display port to thereby display information about both of said first and second programs on a device connected to the first display port, and to provide output of only the first program over a second display port.

17. A method as in claim 16, wherein said first program is displayed to have a first outer shape on a local display connected to said first display port, and said second program is displayed to have a second outer shape different than said first outer shape on said local display.

18. A method as in claim 16, wherein said interacting comprises using a user interface to change said second program such that said second program is also displayed on a remote display connected to said second display port after said changing.

19. A method, comprising:
using a computer to select a first program, and to select whether or not the first program will be displayed on an external display; and
operating the first program, and always providing output indicative of the first program to a port intended for local display of said first program, and providing output indicative of the first program to a second port intended for remote display of the first program only if said program is indicated as being displayed on an external display and not if the program is indicated as not being displayed on said external display.

20. A method as in claim 19, wherein said first program is displayed to have a first outer shape on a local display when it will be displayed also on the external display, and said first program is displayed to have a second outer shape different than said first outer shape on said local display when it will not be displayed on the external display.
